(19) United States
(12) Patent Application Publication
(10) Pub. No.: US 2019/0281807 A1
(43) Pub. Date: Sep. 19, 2019

(54) SPRAYER OR SPREADER BOOM STRUCTURE AND SPRAYER OR SPREADER WITH SUCH A BOOM

(71) Applicant: KUHN-AUDUREAU SA, La Copechagniere (FR)

(72) Inventors: Pascal GAUTRON, Saint-Fulgent (FR); Dimitri LE GUYADER, Cleguer (FR)

(73) Assignee: KUHN-AUDUREAU SA, La Copechagniere (FR)

(21) Appl. No.: 16/356,150

(22) Filed: Mar. 18, 2019

(30) Foreign Application Priority Data
Mar. 19, 2018 (FR) 18 52317

(51) Int. Cl. A01M 7/00; B05B 1/20; A01M 9/00

(52) U.S. Cl. CPC A01M 7/0071; A01M 9/0076; B05B 1/20

(57) ABSTRACT

A boom structure for spraying or spreading including two side poles each formed of at least one segment, each segment or at least one of the segments of each side pole being composed of an assembly of elongated elements including, firstly, a top longitudinal tube, secondly, at least one bottom longitudinal tube and, lastly, bracing elements, forming tie rods and bridging pieces, extending between the top tube and at least one bottom tube, connecting them. A boom structure wherein each longitudinal tube has at least one radial protuberance, shaped in the longitudinal direction of the relevant tube, and including several openings spaced along the tube, each one constituting a site for securing an end of at least one bracing element.

This invention concerns the sector of light-weight, elongated tube structures, enabling a sizeable cantilever and a large-size self-supporting extension, particularly in the sector of agricultural equipment and mechanization.

More precisely, the invention concerns a spreading or spraying boom structure, as well as a sprayer or spreader that is pulled, carried or motorized comprising such a boom.

Sprayers are used to spread or spray chemical products on crops in the form of powder or drops.

Such a sprayer comprises a boom and a tank or reservoir for containing the product to be sprayed. The boom extends on both sides of the vehicle (sprayer pulled or carried) to distribute the product contained in the tank.

The main function of the spraying boom and, particularly its structure, is to support the nozzles and all the tubes in which the spraying products circulate.

The boom must be sufficiently rigid so as not to bend in the course of treatment (constant distance between nozzles and plants), must be as light-weight as possible and must also be able to be folded up to comply with traffic rules on roads. The materials that make up its structure must assure solidity and resistance to corrosion.

Today still, boom structures are often built using steel tubes assembled by mechanic welding and a lattice structure makes it possible to increase the rigidity without overburdening with weight.

The connections between the various tubes are very stressed particularly due to fatigue and by the bending moment due to gravity, which causes the formation of cracks and possibly the rupture of the structure. To limit that risk of rupture of the welds, it is known to locally reinforce those zones of affixing and assembly, but that adds non-negligible weight to the boom. Such repair and maintenance operations require sawing and welding, which is time-intensive.

Moreover, the working width of sprayers is evolving and boom structures are increasingly broad (increased side extensions), and it is increasingly frequent to use materials that lighten the booms, such as aluminum or composite materials. The low density of aluminum makes it possible to use large-sized sections to make rigid booms.

These aluminum boom structures are often made of welded elements and therefore these booms also have weaknesses at the welds. One additional disadvantage with some booms made of aluminum or its alloys lies in the fact that it is not possible to make repairs on the user's premises (agricultural facility, farm), since it requires special welding equipment, which is relatively expensive. Alternatively, the boom segment has to be replaced in its entirety.

In addition, sprayers with booms made of aluminum boom segments that are assembled by flanging/gluing without any welding are known. This boom segment has a triangular-shaped cross section with a narrow top part, a broad bottom part and tie rods that form the sides of the triangle. The tie rods are flanged/glued on the bottom part and on the top part. The broad bottom part has a constant width. A major drawback of this boom is that it is not possible to dismantle the tie rods in the event of breakage and especially that the linear weight is significant, even at the end part.

By documents EP 1 302 107 and EP 2 567 616, boom structures with a trapezoidal or rectangular cross section are also known, comprising profiled elements in the top part and in the bottom part connected to each other by tie rods. These tie rods are affixed to the profiles by means of securing and coupling made up of two complementary parts, trapping between them a hooking edge of one of the profiles and the ends of two tie rods. The tie rods are thus connected to said profiles by pin connections.

However, the booms disclosed by these two documents have a quadrilateral section, with a area that is large and, for document EP 2 567 616 at least, identical over their entire length (hence a bending moment of high intensity). Moreover, the means of double securing that are used show a complex structure and the top and bottom profile parts are specific, non-standard parts with a high cost price. Moreover, the hooking of the securing means on the longitudinal profile parts is done by pinching and only with peripheral regions of these parts. Lastly, two means of securing must be entirely dismantled in order to replace a single tie.

The subject of patent application FR 3 064 156 in the applicant's name is a boom structure that makes it possible to overcome at least the main disadvantages mentioned above.

Nevertheless, in spite of its many advantages, this last boom structure still has a large number of parts to be assembled, does not allow optimal control of the assembly set and of operation and could exhibit greater flexural resistance in the longitudinal tube elements of the boom.

The purpose of the present invention is to overcome at least some of the above-mentioned limitations.

For this purpose, its subject is a spreading or spraying boom structure comprising two side poles, each made up of at least one segment, these two side poles being advantageously arranged on both sides of a central segment,

the single segment, each segment or at least one of the segments of each side pole being composed of an assembly of elongated elements comprising, on the one hand, a top longitudinal tube, on the other hand, at least one bottom longitudinal tube and, lastly, bracing elements, forming tie rods and bridging pieces, extending between the top tube and the said at least one bottom tube, connecting them,

boom structure characterized in that each longitudinal tube has at least one radial protuberance, shaped in the longitudinal direction of the relevant tube, and comprising at least one opening, preferably several openings spaced along said tube, constituting a site for securing one end of at least one bracing element.

The invention will be better understood, thanks to the following description, which refers to preferred embodiments, given as nonrestrictive examples, and explained with reference to the attached schematic drawings, in which:

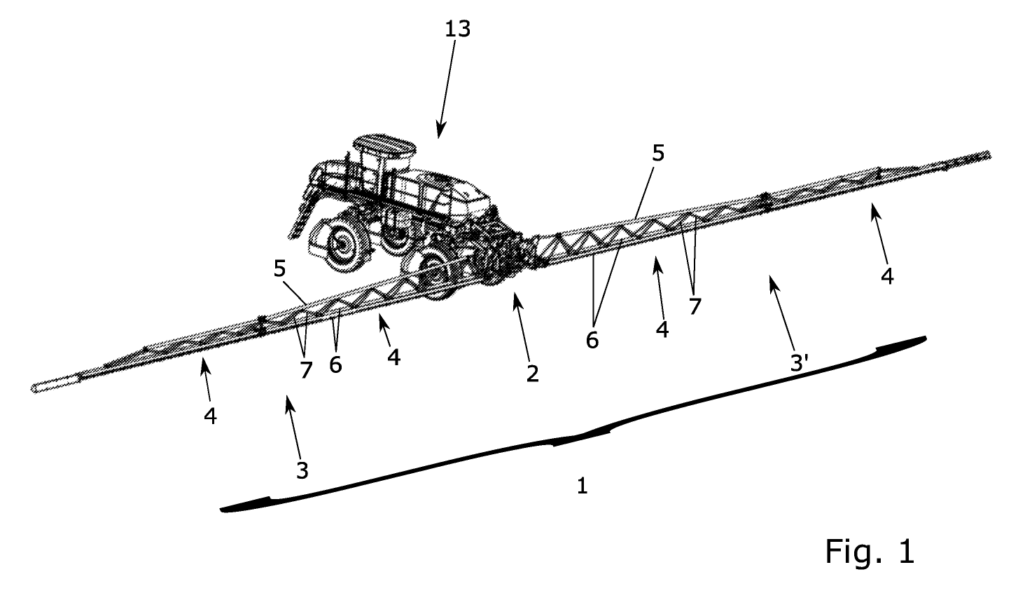

FIG. 1 is a top view of a sprayer equipped with a boom structure according to one embodiment of the invention;

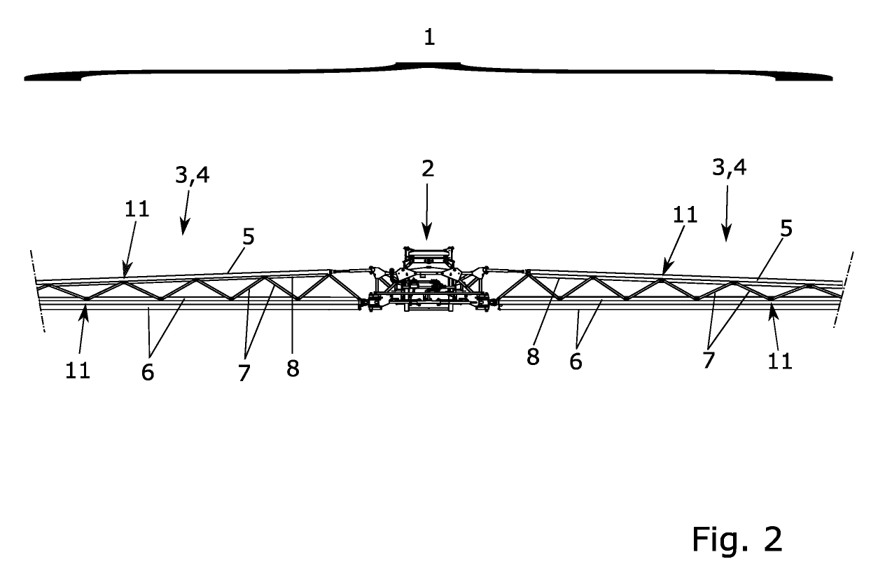

FIG. 2 is a partial front elevation view of a boom structure according to the embodiment of the invention in FIG. 1;

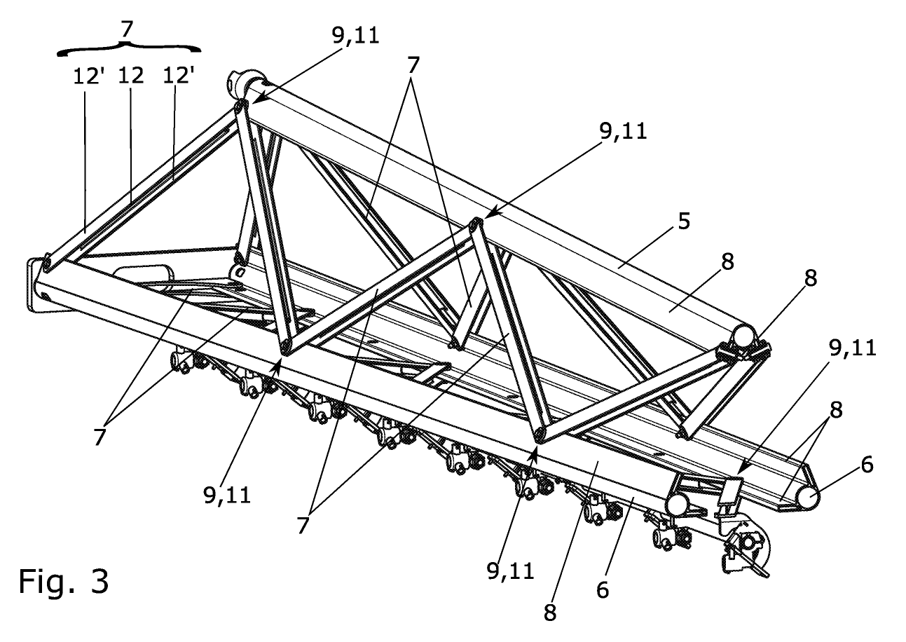

FIG. 3 is a perspective view of a part of a boom segment as shown in FIGS. 1 and 2;

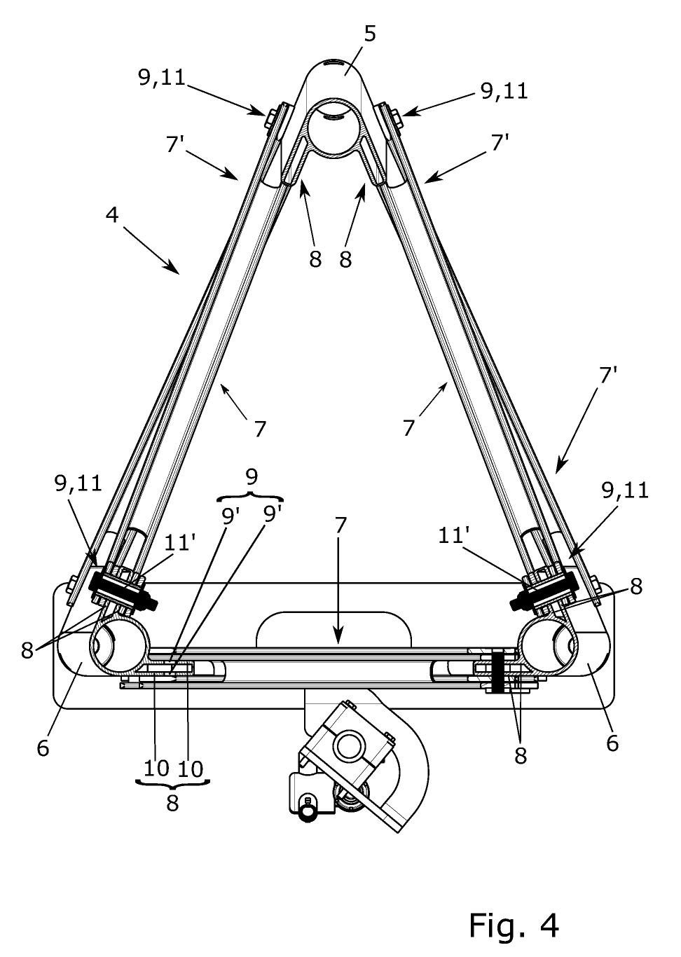

FIG. 4 is a cross-section view, on a different scale and according to a plane passing through two bottom affixing points, of the segment shown FIG. 3;

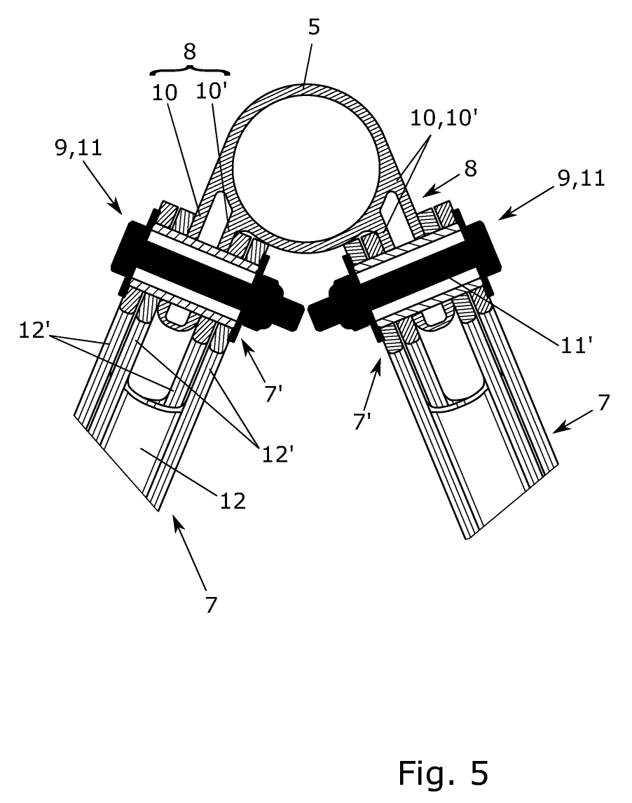

FIG. 5 is a cross-section view of the top part of the segment shown in FIG. 3, on a different scale and according to a plane passing through two top affixing points;

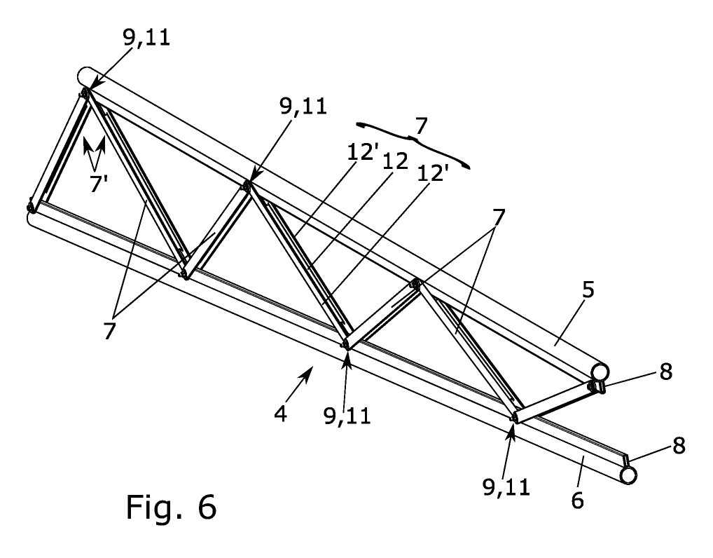

FIG. 6 is a perspective view similar to the one in FIG. 3 of a boom structure pole segment, according to another embodiment of the invention;

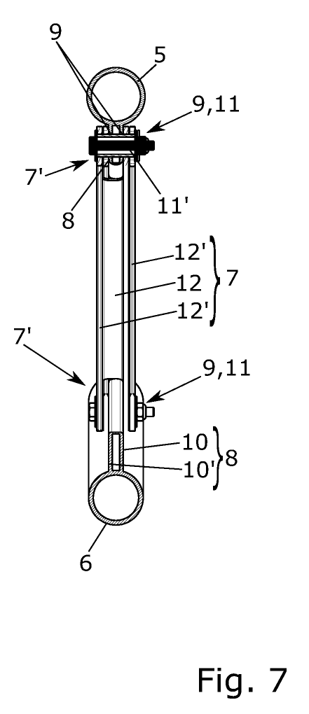

FIG. 7 is a cross-section view, on a different scale and according to a cross-section plane passing through a top affixing point, and,

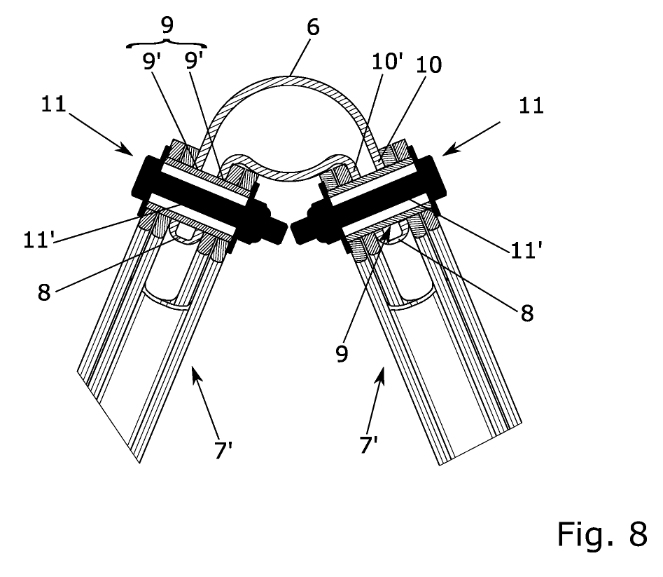

FIG. 8 is a view similar to the one in FIG. 5, illustrating an alternative embodiment of the top longitudinal tube.

FIGS. 2 to 8 of the attached drawings show, at least in part, a boom structure 1 for spraying or spreading comprising two side poles 3, 3′ each formed of at least one segment 4, these two side poles 3, 3′ being advantageously arranged on both sides of a central segment 2.

The single segment 4, each segment 4 or at least one of the segments 4 of each side pole 3, 3′ consists of an assembly of elongated elements 5, 6, 7 comprising, firstly, a top longitudinal tube 5, secondly, at least one bottom longitudinal tube 6 and, lastly, bracing elements 7, forming tie rods and bridging pieces, extending between the top tube 5 and the said at least one bottom tube 6, connecting them.

The concepts “top” and “bottom” are to be considered when the boom 2 is deployed, in a situation of normal use.

Pursuant to the invention, each longitudinal tube 5, 6 has at least one radial protuberance 8, shaped in the longitudinal direction of the relevant tube 5, 6, and comprising at least one opening 9, preferably several openings 9 spaced along the said tube 5, 6, (possibly each) composing a site for securing an end 7′ of at least one bracing element 7.

Thanks to the invention, it is possible to arrive at the advantages mentioned in relation to the invention of the applicant's aforesaid prior patent application, even with better performance, in terms of flexural strength, rigidity and reduction in play, all while limiting the number of constituent parts and pieces.

Indeed, the or each radial protuberance 8, made of only one tie rod with the relevant tube 5, 6, incorporates the securing sites 9 for the bracing elements 7 and simultaneously helps to make the relevant tube 5, 6 more rigid.

Moreover, the openings 9 that form sites could be made precisely at the time when the tube 5, 6 is manufactured.

In order to arrive at a light-weight construction that facilitates securing by hooking in the openings 9, the protuberance or each shaped protuberance 8 is advantageously hollow and has advantageously two portions of opposite flat walls 10, 10′ in each of which perforations 9′ are made that form openings 9 by cooperation.

Preferably, and as shown in FIGS. 3 to 5, 7 and 8, it can be planned that the or each shaped protuberance 8 consists of a hollow wing-shaped projection made of only one holder with the tube concerned 5, 6, extending at least over the entire length thereof and having two side walls 10 and 10′ facing each other comprising perforations 9′ coinciding two by two and forming openings 9 by cooperation traversing the relevant protuberance 8 (perpendicularly to the medial plane of the flat aid forming the protuberance 8).

Thus the rigidity of the tubes 5, 6 will be increased in the plane of the bracing elements 7.

Perforations 9′, preferably, are made by perforative machining on each side of the relevant protuberance 8, allowing easy setup and a controlled assembly and operation clearance.

In accordance with one very advantageous characteristic of the invention, each opening 9 constitutes a site for securing the bearing type pin connection 11 connecting one end 7′ of at least one bracing element 7 to the relevant shaped protuberance 8.

Such a type of connection is an ideal solution for the assembly being considered, to wit a good compromise between the total rigidity of a weld (involving a risk of rupture due to fatigue) and the limited rigidity of a ball-and-socket connection (low rigidity in torsion of the segment).

According to one optimized construction variant, deriving from FIGS. 2, 3 and 6, each of the bracing elements 7 connecting the top tube 5 with the or one of the bottom tube(s) 6 is joined, by one of its ends 7′, with a preceding element 7 and, by its other end 7′, with a following element 7. Moreover, these adjoining bracing elements 7 all are located in the same plane and are arranged with opposite successive inclines, two successive bracing elements 7 being coupled between them and coupled with the tube concerned 5, 6 by the same pin connection 11, incorporating, as a bearing, an opening 9 made in the relevant protuberance 8 of the relevant tube 5, 6.

As an example of advantageous practical embodiment, each securing pin connection 11 can consist of an assembly by screw/nut (see FIGS. 4, 5, 7 and 8). Such an embodiment is not only sturdy, simple and inexpensive, it also makes it possible to unsecure and dismantle one of the two tie rods or bridging pieces 7 of an affixing point 11, while keeping the other secured.

As an alternate example of embodiment, the securing pin connection 11 can also consist of an assembly with a double-mount spring pin or an analogous means that limits the play or takes up the slack in the aforementioned connection.

As shown in FIG. 8, each one or at least one of the tubes 5, 6 can have, in section, a non-compartmentalized structure and have a single wall that forms an envelope and defines the body of the tube and the radial protuberance(s), with no marked limit between these various parts.

However, according to one preferred embodiment, each of the tubes 5, 6 has a circular basic section, on which the or each protuberance 8 is formed, the tube 5, 6 concerned being preferably compartmentalized in section.

A circular-shaped tube body provides a particularly good resistance to torsion stresses.

In order to lighten the boom structure 1 without however compromising its rigidity, it can be planned that each bracing element 7 has an H-shaped cross-section, whose core 12 is shorter longitudinally, and preferably less thick, than its side wings 12′, the core 12 being absent at the two opposite ends 7′ of the relevant bracing element 7, which are bored for receiving a pin connection 11 axle 11′ that cooperates with an opening 9 that forms a securing site.

In accordance with a first embodiment, deriving from FIGS. 6 and 7, the or each segment 4 comprises only a single bottom tube 6, the top 5 and bottom 6 tubes each comprises only one shaped protuberance 8, and the said segment 4 has a flat overall structure, and the spacing between the two tubes 5, 6 decreases from one end to the other of the said segment 4.

A progressive reduction in size of segment 4 along its longitudinal direction makes it possible to arrive at a boom structure that is lighter overall, with its own bending moment that is smaller and decreases rapidly toward the free end of the side poles 3, 3′, and with reduced stresses at the hooking interface of the said poles 3, 3′ with the central segment 2.

In accordance with a second embodiment, deriving from FIGS. 1 to 5 and 8, the or each segment 4 comprises two bottom tubes 6 arranged with the top tube 5 according to a triangular configuration. Moreover, each of the top 5 and bottom 6 tubes has two shaped protuberances 8, shifted angularly around the longitudinal axis of the relevant tube 5, 6, and the triangular prism composed by the said segment 4 has a cross section that decreases from one end to the other of the said segment 4.

In this variant, the three faces of the triangular prism, to with the bottom face and the two side faces, are made of bracing elements 7. The sprayers can for example be hooked to the elements 7 of the bottom face of the segment 4.

In this construction variant, at least the two bottom tubes 6 (isosceles section), or even the three tubes 5 and 6 (equilateral section), can be identical.

Preferably, the cross section of segment 4 has an isosceles triangular shape, and the width of the base and the height of the section vary similarly from one end to the other of the said segment 4. In this variant, the base of the triangular prism formed by the segment 4 is located near the ground in a deployed state of the boom structure 1.

In the two aforementioned embodiments, the progressive reduction in the section from one end to the other of a relevant segment 4 also translates, for identical bracing elements 7, into a change in their incline compared to the tubes 5 and 6 (reduction in angle 5/7 and 6/7 at the pin connections 11).

It is understood that each side pole 3, 3′ can comprise one, two or several segments 4, the smallest section of a segment 4 corresponding roughly to the next largest section of segment 4 in the direction of the free end of the relevant pole 3, 3′ (end opposite to the central segment 2).

As shown in FIG. 1 as an example, each side pole 3, 3′ can comprise not only one or more segments 4 with decreasing section, but also one or more segments with constant section (tubes 5 and 6 parallel between them).

Another subject of the invention, as shown in FIG. 1, is a machine 13 for spraying or spreading, of the type that is pulled, carried or motorized, comprising specifically at least one tank, means of circulating the product, one or more distribution circuits and a boom on which the means of ejecting the product are mounted, this machine 13 being characterized in that the boom has a boom structure 1 as previously described.

Of course, the invention is not limited to the embodiments described and shown in the attached drawings. Modifications remain possible, particularly from the standpoint of the composition of the various elements or by substituting technical equivalents, without however departing from the invention's field of protection.

1. A boom structure for spraying or spreading comprising two side poles each formed of at least one segment, these two side poles being advantageously arranged on both sides of a central segment,
the single segment, each segment or at least one of the segments of each side pole being composed of an assembly of elongated elements comprising, firstly, a top longitudinal tube, secondly, at least one bottom longitudinal tube and, lastly, bracing elements, forming tie rods and bridging pieces, extending between the top tube and said at least one bottom tube, connecting them,
wherein each longitudinal tube has at least one radial protuberance, shaped in the longitudinal direction of the relevant tube, and comprising at least one opening, preferably several openings spaced along said tubes, constituting a site for securing an end of at least one bracing element.

2. The boom structure according to claim 1, wherein the protuberance or each shaped protuberance is hollow and has advantageously two portions of opposite flat walls in each of which perforations are made that form openings by cooperation.

3. The boom structure according to claim 1, wherein each shaped protuberance consists of a hollow wing-shaped projection made of a single holder with the tube concerned, extending at least over the entire length thereof and having two side walls facing each other comprising perforations that coincide two by two and form, by cooperation, openings that traverse the protuberance concerned.

4. The boom structure according to claim 1, wherein each opening constitutes a site for securing the bearing type pin connection connecting one end of at least one bracing element to the shaped protuberance concerned.

5. The boom structure according to claim 1, wherein each bracing element connecting the top tube with one of the bottom tube(s) is joined, by one of its ends, with a preceding element and, by its other end, with a following element, in that wherein these adjoining bracing elements all are located in the same plane and arranged with opposite successive inclines, two successive bracing elements being secured to each other and secured with the tube concerned by the same pin connection integrating, as a bearing, an opening made in the protuberance concerned of the relevant tube.

6. The boom structure according to claim 1, wherein each tube has a circular basic section, on which each protuberance is formed, the tube concerned being preferably compartmentalized in section.

7. The boom structure according to claim 1, wherein each bracing element has an H-shaped cross section, whose core is shorter longitudinally, and preferably less thick than its side wings, the core being absent at the two opposite ends of the relevant bracing element, which are bored for receiving a pin connection axle that cooperates with an opening that forms a securing site.

8. The boom structure according to claim 1, wherein each segment comprises only a single bottom tube, in that the top and bottom tubes (5, 6) each comprise only one shaped protuberance and wherein said segment has a flat overall structure, and the space between the two tubes decreases from one end to the other of said segment.

9. The boom structure according to claim 1, wherein each segment comprises two bottom tubes arranged with the top tube according to a triangular configuration, in that each top and bottom tube has two shaped protuberances, shifted angularly around the longitudinal axis of the tube concerned, and wherein the triangular prism composed by said segment has a cross section that decreases from one end to the other of said segment.

10. The boom structure according to claim 9, wherein the cross section of the segment has an isosceles triangular shape, the width of the base and the height of the section varying similarly from one end to the other of [[the]] said segment.

11. A machine for spraying or spreading, of the type that is pulled, carried or motorized, comprising specifically at least one tank, means of circulating the product, one or more distribution circuit(s) and a boom on which the means of ejecting the product are mounted, wherein the boom has a boom structure according to claim 1.
